(19) United States
(12) Patent Application Publication
(10) Pub. No.: US 2008/0040681 A1
(43) Pub. Date: Feb. 14, 2008

(54) System and Method for Automatically Updating a Widget on a Desktop

(76) Inventors: Don Synstelien, Marietta, GA (US); Jesse Edwards, Hiram, GA (US); Frank Spitzka, Marietta, GA (US); Michael Ayers, Atlanta, GA (US)

Correspondence Address: CANTOR COLBURN, LLP, 55 GRIFFIN ROAD SOUTH, BLOOMFIELD, CT, 06002, US

(21) Appl. No.: 11/837,791

(22) Filed: Aug. 13, 2007

Related U.S. Application Data
(60) Provisional application No. 60/822,137, filed on Aug. 11, 2006.

(51) Int. Cl. G06F 3/048

(52) U.S. Cl. 715/765

(57) ABSTRACT

The present invention provides a system and method for automatically updating a widget on desktop. The system includes a receiving module that receives widget data from a desktop application and a version determination module that determines if the widget being launched is the most current. In addition, the system includes a download module that downloads at least one component for the widget if a newer version is available. The present invention can also be viewed as a method for automatically updating a widget on desktop. The method operates by receiving widget data from a desktop application, determining if the widget being launched is the most current, and downloading at least one component for the widget if a newer version is available.

### CROSS-REFERENCE TO RELATED APPLICATION

This application claims priority to copending U.S. provisional application entitled, “METHOD FOR DRAGGING AND DROPPING A BROWSER OBJECT ONTO A DESKTOP,” having Ser. No. 60/822,137, filed Aug. 11, 2006, which is entirely incorporated herein by reference.

### TECHNICAL FIELD

The present invention is generally related to software for computers and, more particularly, is related to a system and method for automatically updating a widget on desktop.

### BACKGROUND OF THE INVENTION

It is well known to drag and drop an item, such as a selected word, phrase or paragraph, within a document. It is also well known to drag and drop an object, such as an icon or shortcut, from one place on a desktop to another place on a desktop. It is also well known to drag and drop a file from one hard drive to another hard drive (although in that instance a copy is placed on the destination drive). It is also well known to open an application or a file by dragging the file over the icon for that application.

When viewing something on the Internet using a web browser, one can copy and paste an object from the browser window to the desktop, one can select an object in the browser window and “save as . . . ” onto the desktop, one can click on a corresponding download button if provided and save it to the desktop, or one can drag and drop a URL address from either the history window of a web browser or the address field of a web browser onto the user's desktop to create a shortcut icon on the desktop to that URL.

In addition, one can drag and drop certain items onto the desktop from a web browser, but this generally only works with text “clippings” and images on the Mac platform, and that implementation leaves these items dragged as icons only and the user has to take specific action to open them. Further, one can drag a URL address from a window in a web browser to the desktop in order to create a shortcut to that address on the desktop, or drop it onto a printer icon on the desktop to cause the web page to be printed.

However, once the object is on a desktop there are no systems in place to update the object to ensure that it is in the most current state.

### SUMMARY OF THE INVENTION

Embodiments of the present invention provide a system and method for automatically updating a widget on desktop. Briefly described, in architecture, one embodiment of the system, among others, can be implemented as follows. The system includes a receiving module that receives widget data from a desktop application and a version determination module that determines if the widget being launched is the most current. In addition, the system includes a download module that downloads at least one component for the widget if a newer version is available.

Embodiments of the present invention can also be viewed as providing methods for automatically updating a widget on desktop. In this regard, one embodiment of such a method, among others, can be broadly summarized by the following steps. The method operates by receiving widget data from a desktop application, determining if the widget being launched is the most current, and downloading at least one component for the widget if a newer version is available.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram illustrating an example of the network environment for placement of browser objects utilizing the widget system of the present invention.

FIG. 2A is a block diagram illustrating an example of a server utilizing the widget system of the present invention, as shown in FIG. 1.

FIG. 2B is a block diagram illustrating an example of a remote device utilizing the remote widget system of the present invention, as shown in FIG. 1.

FIG. 3 is an example of the logical grouping of widget files in a server database and association with these groups according to the principles of the widget system of the present invention, as shown in FIGS. 1, 2A and 2B.

FIG. 4A is a flow chart illustrating an example of the operation of the widget system of the present invention utilized by the server, as shown in FIGS. 2A-3.

FIG. 4B is a flow chart illustrating an example of the operation of the remote widget system of the present invention utilized by the remote device, as shown in FIG. 2B.

FIG. 5A is a flow chart illustrating an example of the operation of the widget submission process on the server that is utilized in the widget system of the present invention, as shown in FIGS. 2A and 4A.

FIG. 5B is a flow chart illustrating an example of the operation of the widget submission agent on the remote device that is utilized in the widget system of the present invention, as shown in FIGS. 2B and 4B.

FIG. 6A is a flow chart illustrating an example of the operation of the widget embed process on the server that is utilized in the widget system of the present invention, as shown in FIGS. 2A and 4A.

FIG. 6B is a flow chart illustrating an example of the operation of the widget embed agent on the remote device that is utilized in the widget system of the present invention, as shown in FIGS. 2B and 4B.

FIG. 7A is a flow chart illustrating an example of the download process on the server that is utilized in the widget system of the present invention, as shown in FIGS. 2A and 4A.

FIG. 7B is a flow chart illustrating an example of the operation of the drag and drop agent on the remote device that is utilized in the widget system of the present invention, as shown in FIGS. 2B and 4B.

FIG. 7C is a flow chart illustrating an example of the operation of the pop agent on the remote device that is utilized in the widget system of the present invention, as shown in FIGS. 2B and 4B.

FIG. 7D is a flow chart illustrating an example of the operation of the widget acquire agent on the remote device that is utilized in the widget system of the present invention, as shown in FIGS. 2A and 2B.

FIG. 8A is a flow chart illustrating an example of the widget launch process on the server that is utilized in the widget system of the present invention, as shown in FIGS. 2A and 4A.

FIG. 8B is a flow chart illustrating an example of the operation of the widget launch agent on the remote device that is utilized in the widget system of the present invention, as shown in FIGS. 2B and 4B.

FIG. 8C is a flow chart illustrating an example of the operation of the new widget agent on the remote device that is utilized in the widget system of the present invention, as shown in FIGS. 2B and 4B.

### DETAILED DESCRIPTION

A system and method is provided which automatically updates a widget on desktop. In practice, whenever an object is executed a test is done to insure that the object is the most current version. If it is determined that the object is the most current version, then the object is executed without further interruption. However, if it is determined that a new version of the object is available, then the new object is downloaded and preferably superimposed over the outdated object.

More particularly described, the user will use his/her computer to visit an Internet web site. The user's computer will need to have installed thereon an Internet browser or another application that can run media, for example, Flash content. In an alternative embodiment, streaming media could be used. For example, one could have a standalone Flash Player, and launch a Flash clip therein and, if that Flash clip presented a pop button, then if the user clicks on that pop button the base program will create and present a corresponding desktop widget window. As another example, one could have a multimedia application, such as PowerPoint™, and embed a pop button inside a PowerPoint presentation. If the user clicks on that pop button then the base program will create and present a corresponding desktop widget window. This occurs even if the Flash clip or PowerPoint presentation is stored locally, such as on the user's computer or on a local area server. In many cases, or even most cases, the user will be using an Internet browser. Therefore, for convenience of the following discussion, the term “browser” will be used as being representative of any application that can run media in which a pop button can be embedded.

In computer programming, a widget is anything that can be embedded within a page of HTML, i.e. a web page. A widget adds some content to that page that is not static. Widgets are also known as modules, snippets, and plug-ins. Widgets can be written in HTML, but also in JavaScript, Flash and other scripting languages that will be run when the page is called.

Widgets are normally used by computer users that include, but are not limited to, bloggers, social network users, auction sites and owners of personal web sites. They exist on home page sites such as iGoogle, Netvibes, Pageflakes, SpringWidgets and yourminis (and a multitude of others). Widgets can be used as a distribution method by ad networks such as Google's AdSense, by media sites such as Flickr, by video sites such as YouTube and by hundreds of other organizations.

Widgets can be integrated within a third party website as browser objects by the placement of a small snippet of code. This is becoming a distribution or marketing channel for many companies. The code brings in ‘live’ content—advertisements, links, images—from a third party site without the web site owner having to update.

End users can utilize web widgets to enhance a number of web-based hosts, or drop targets. Categories of drop targets include, but are not limited to, social networks, blogs, wikis and personal home pages. Although end users primarily use web widgets to enhance their personal web experiences, or the web experiences of visitors to their personal sites, corporations can potentially use web widgets to improve their web sites using syndicated content and functionality from third party providers.

A widget can also be a stand alone or self-contained chunk of code that appears as a mini-application on a user's desktop. This desktop widget runs inside a small footprint application, which resides on the user's desktop using a small desktop space and computer resources, such as the HDD and RAM. Yet, a desktop widget provides relevant information to the user in a non-intrusive manner. Basically, desktop widgets enable the user view on demand, encapsulated information from a data source(s). Ideally, a desktop widget presents personalized content, based on the user's preferences.

A desktop widget typically provides easy access to frequently used functions, information and the like or provides visual display of that information. Typical widgets include, but are not limited to, news aggregators, clocks, calculators, calendars, desktop notes and weather forecasts.

In computer programming, a browser object is a block of code referencing the necessary files for displaying specific contents. For examples, an image browser object would call an image file in order to display an image. A widget browser object would call a widget wrapper and would load into it the widget file and any necessary parameters.

The user's computer will also have the base program installed and operational thereon. The base program may be installed by any convenient method, for example, via a disk, or by downloading. If the base program is not installed and operational then the user will be prompted to download and install it. This installation happens inside the wrapper rather than lining to page on our site.

The browser is used to visit an “associated” web page of an “associated” web site. An associated web site is one which has at least one associated web page, and an associated web page is one which has at least one widget wrapper on it.

A widget wrapper is preferably implemented and executed as, for example, a flash file, which may be run by, for example, an application, or a plug-in for a browser or another application. The widget wrapper preferably provides the following functions: (1) it provides a blank (standard, default) widget container for the widget to load into; (2) it may include custom or generic pop and download buttons and a menu; (3) it specifies the widget parameters, including but not limited to which widget is to be used and any custom parameters that are to be passed into that widget; (4) it downloads the specified widget file from a widget server and opens (executes) the downloaded widget into the widget container; (5) it passes the custom parameters specified in the web page into the widget; (6) it contains some application programming interface (API) functions (for example, determining the size the web page widget needs to take) for the widget to access; and (7) it provides “sniffer” code which checks whether the base program has been installed and/or is operational. (8) Has support for advertising and leave behinds (9) Allows a Widget to be displayed in fullscreen (10) supports tracking for user interactions as will as ad impressions.

There are preferably multiple types of widgets such as, for example, a stock ticker widget, a news headline widget, a sports headline widget, a weather widget, a movie trailer widget, a book review widget, etc., and each type of widget preferably, but not necessarily, has a different appearance and/or functionality. For example, a stock ticker widget might have one appearance, and expect to receive data in a certain format, whereas a weather widget might have another appearance, and expect to receive data in a different format.

In addition to the name, type, or other designation of the desired widget, the widget presentation parameters also preferably include: the widget max/min height (for example, in pixels), the widget max/min width, the x and y coordinates on the screen (or other data specifying the location of the widget on the web page and screen); the name, address and/or location (for example, the URL) of the widget on the widget server; and, if the widget programming requires it, the name and/or location of the information which is to be presented via the widget, such as a ticker symbol(s), ZIP code(s), URL address providing that information, etc.

A widget server contains the files which provide the code for at least one widget type, and may contain the code for many or even all widget types. The widget wrapper accesses the widget server, requests and downloads the file for the specified widget, and then executes the downloaded widget file. The downloaded widget, at this point, is the specified type of widget but is blank or, if desired, may provide some default information. For example, the downloaded widget may be stock ticker widget, and may be blank and not present any stock information, or could present a default stock ticker symbol or other information.

The widget wrapper passes the widget presentation parameters to the widget, which may contain state and/or user parameters specifying data that the widget needs to load. The widget accepts these presentation parameters, uses them to access the server(s) which contain the desired presentation information, downloads the desired presentation information, and then presents the downloaded information to the user. The widget may then request periodic updates of the presentation parameters from that server. Alternatively, that server may push updated presentation parameters to the widget. Thus, a widget may be viewed as being tuned or dedicated to a particular source for presentation parameters.

It is also possible to replace or modify feature(s) of the widget wrapper, such as the pop button or the download button. The code for the specified widget type may also provide certain functions for the widget, such as fast forward, next, play, stop, etc., although certain of these features may not be enabled in the widget presented in the browser.

The presentation parameters for a stock ticker widget might be, for example, a stock ticker symbol, and/or may include the name and/or URL of a server which can provide the desired stock pricing information in the desired format for presentation. A stock ticker widget would access that server, the server would accept the stock ticker symbol and provide stock price and/or other information for that stock ticker symbol, and the stock ticker widget would present, such as by displaying, the stock price and/or other information for that stock ticker symbol. As another example, the presentation parameters for a weather widget might be a ZIP code and/or the URL of a server which can provide weather information based upon the ZIP code. As another example, the presentation parameters for a sports widget might be a team name and/or the URL of a server which can provide sports information based upon the team name, for example, current game and/or team information, team player lists and injury status, etc.

Some parameters passed into the widget may or may not be presentation based. State parameters may not tell the widget what data to pull from a server but instead just tell it which tab should be the default tab. For example, a weather widget may have three tabs: current conditions, forecast and maps. In addition to, or instead of, the parameters providing a zipcode list, there may also be a parameter to tell the widget to display the information under the forecast tab by default rather than current conditions.

Once the widget has received the presentation information from the server then the widget presents that presentation information to the user, preferably as text, video, image, sound, or any combination thereof. It should be noted that a widget may present only a single item, or may present several different items of the same kind. It may display text, image and sound items at the same time too. It doesn't have the same data type to show multiple items. For example, a stock ticker widget may present stock information for one, two, or more ticker symbols. Likewise, a weather widget may present weather information for one, two or more locations (for example, ZIP codes) and/or general (statewide, region wide, or even countrywide) information.

The browser may display several web page widget windows simultaneously, each web page widget window may present a different widget, each widget may be tuned to a different source, and each web page widget window may have different functionality. For example, there could be two or three stock ticker widget windows, each presenting different stock ticker information, and there could also be a Really Simple Syndication (RSS) feed widget window presenting an RSS feed from a specified source, and there could also be a news widget presenting news information. These web page widgets are therefore all functional. It is likely, however, that at some point the user will want to use the browser to view a different web page so the user will want certain widgets to remain even after the browser is closed or is viewing a different web page.

If the user wishes to pull the widget down to their desktop, They may “pop” or drag and drop the widget to the desktop, if the base program has not been installed and/or is not operational then the sniffer will cause a download button to be present on the widget wrapper window(s). The download Button may or may not look the same as the pop button. If the user clicks the download button on a widget wrapper window then the user is presented with the option of having the base program downloaded and installed. Once the base program is installed and operational then the download button will change to be a “pop” button without a page refresh being required. In fact, the widget that is inside the wrapper that the user interacted with in order to install the application will automatically pop when the application starts up after the install, but only if the user did not navigate away from the webpage and was not refreshed.

If the base program has been installed and is operational then the sniffer will cause a pop button to be present on the widget wrapper window(s). If the user clicks the pop button on a widget wrapper window then the base program will cause a desktop widget window to appear.

If the base program is installed, but not operational, then the pop button will be presented and clicking on the pop button will cause the widget wrapper to cause the base program to be executed, and then operation will proceed as if the base program had been operational all along.

When the user clicks the pop button the web page widget wrapper sends, to the base program, at least some of the widget parameter information originally present in the web page, such as the name of the widget on the widget server the height, width and the X,Y coordinates of the widget on the screen, and certain custom parameters, for example, a URL of the data source. The web page widget wrapper preferably also sends, to the base program, the URL of the widget on the widget server, at least some of the widget parameters originally present in the web page and/or previously downloaded from the widget server, and/or the name or location of the information which is to be presented via the widget, such as a stock ticker symbol, ZIP code, URL of the information, etc.

In the preferred embodiment, the base program is constantly checking for that information from the web page widget wrapper. The base program, upon receiving this information, checks to ensure that the widget information exists on the remote device. If the widget information does not exist on the remote device, then the base program communicates with the widget originating server to download the most current version of the widget. However, if the widget information exists on the remote device, then the base program communicates with the widget originating server to determine if a more current version of the widget is available. If a more current version of the widget is available, then the base program downloads the new version of the widget.

Once the base program checks the version of the widget it then creates a blank widget window and then completes the widget window based upon the widget type and other information passed from the web page window wrapper. The desktop widget window preferably presents the same presentation information as was present in the browser widget window at the time the user clicked the pop button. Before the widget is loaded, a security feature makes sure that the widget is from a trusted source, if it is not, the user may choose to allow or deny that download of the widget. Once loaded, the desktop widget contacts the information source(s) to obtain the current information to be presented in the widget. Thus, a live widget has been transferred from the web browser environment to the desktop environment.

It is preferable that the web page widget wrapper also pass, directly to the base program, the information which the web page widget is currently displaying, the widget parameters specified in the web page widget wrapper, such as the URL of the widget file, the information source name or address, the display information (height, width, margins, etc.). However, if desired, the widget wrapper could simply pass to the base program only the information in the web page widget wrapper, and then the base program would contact the widget server to request and download the specified widget and the base program and/or the executed widget would contact the server(s) to obtain the remaining presentation information.

Transferring the width, height, and location of the web page widget as it is on that web page allows the base program to create and position the desktop widget with that same, or nearly same, width and height, so it appears that an identical instance of that widget was actually popped from the web page. For example, if the widget on the web page is 100×100 pixels, and it is popped, the web page widget wrapper will pass that 100×100 parameter to the base program, and the desktop widget would then also take the size of 100×100. If the web page widget wrapper also passes the top margin and left margin, or other location information, to the base program then the base program will know where on the desktop to position the desktop widget window so that the desktop widget window is in the correct position on the screen, that is, superimposed over the web page widget window and in very close proximity to, if not in the identical position of, the web page widget window.

The desktop widget window is preferably superimposed on top of the corresponding web page widget window, and preferably hides some or, more preferably, hides all, of the web page widget window. This can occur because the web page widget window information (height, width, location) has been passed to the base program. As the desktop widget window is already on the desktop it can be moved by the user from one place on the desktop to another place on the desktop. The desktop widget window is preferably superimposed on top of the web page widget window and is preferably similar to or identical to the web page widget window, so that when the user drags the desktop widget window from its original location on the desktop (superimposed on top of the web page widget window) to a new location on the desktop, the user believes that s/he is dragging the widget from the browser to the desktop and dropping it on the desktop.

The user is not required to move the desktop widget window, but will probably desire to do so in order to move the desktop widget window outside of the area of the web browser window.

Also, the user is not limited to popping a single widget. The user can pop multiple widgets for the same or a different wrapper. Each time the user clicks on the pop button the base program creates and presents a new instance of a desktop widget, that new desktop widget instance corresponding to the web page widget instance for which the user clicked the pop button. Thus, there may be multiple web page and multiple desktop widgets, all running simultaneously if desired.

The desktop widget window may be identical to, substantially identical to, similar to, or even completely different from, the web page widget window. For example, media player controls in the web page widget window may have small buttons due to web page real estate considerations, but those same buttons may be larger and/or repositioned in the desktop widget window, especially if the desktop widget is scalable.

A widget may, if desired, present various user controls, such as play, pause, forward, backward, close, etc. Thus, the user could go to an associated sports web site, click on the pop button of a web page widget for the Superbowl, and then, via the downloaded widget, hear and/or see the Superbowl pre-game show, game, post-game commentary, etc. Or, the user could go to an associated financial web site, click on the pop button of a web page widget for a ticker tape symbol, and then hear and/or see, via the downloaded widget, stock or financial news announcements for that particular stock symbol. Also, a widget window may have a predetermined, general, or default look and feel or it may obtain a customized look and feel from the downloaded parameters. A widget may present text, pictures, audio, video, etc.

Once the user has clicked the pop button on the web page widget window, then the user is free to close the browser, use the browser to view another website, download another widget, etc.

If the user closes the web browser the web page widget window would disappear but the desktop widget window would still be present on the desktop because the desktop widget is being run inside an instance of the desktop widget which is being run by the base program, not by the browser. If the user, instead, closed the base program, all desktop widget windows would disappear but the web page widget window would still be present as it is being run by a different program, the browser.

The desktop widget parameters are preferably saved by the base program on closing the base program so that the next time the user starts the base program the desktop widget(s) would be opened and would re-appear in the same place and state (and with the same data but with current presentation information) as it was in when the base program was closed. The base program may run several desktop widgets simultaneously and each desktop widget would also re-appear in the same place and state it was in when the base program was closed.

As mentioned, although the widget web wrapper provides certain API functions, and although the widget code may provide for certain functions, some of those functions may not be available in the web page widget. For example, a function which might be available for a desktop widget, but not for a web page widget, is a close button. Thus, even if certain functions are present in the widget code because the same widget code is used for both the web page widget and the desktop widget, those lines of code that reference those and other particular functions do not do anything because they are not declared in the web page widget wrapper and because they are not applicable. On the desktop, however, the base program can declare those particular functions and then they can be used. In addition one can also provide and use certain API functions, for example, Widget environment, to determine what environment the widget is in (browser or desktop), and branch to or execute different segments of code based on that.

In the preferred embodiment, if the user clicks on the pop button then the web page widget wrapper simply passes the widget parameters from the web page to the base program. The base program will then use that information to check with the widget originating server to determine if a more current version of the widget is available. If a more current version of the widget is available, then the base program downloads the new version of the widget.

Accordingly, briefly described, one embodiment of the present invention operates as follows:

(i) the user clicks on the widget button on a web page widget window then the widget window sends certain information for that widget to the base program;

(ii) the base program sends that information to the widget originating server to check that the widget is the most current version of the widget;

(iii) the widget originating server then verifies that the widget version received from the base program is the most current version of the widget and returns the most current widget data to the base program if the widget received is not the most current version; and

(iv) the base program then can execute the widget.

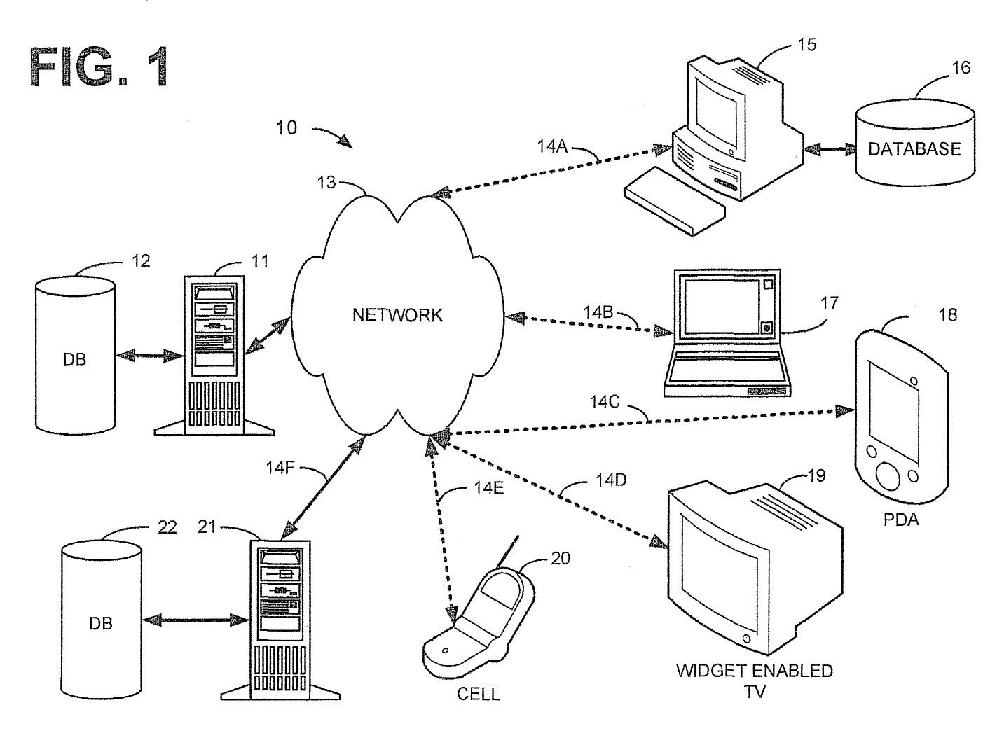

Referring now to the drawings, in which like numerals illustrate like elements throughout the several views, FIG. 1 illustrates an example of the basic components of a system 10 using the widget system used in connection with the preferred embodiment of the present invention. The system 10 includes a server 11 and the remote devices 15, 17, 18, 19 or 20 that utilize the widget system of the present invention.

Each remote device 15, 17-20 has applications and can have a local database 17. Server 11 contains applications, and a database 12 that can be accessed by remote device 15, 17-20 via connections 14(A-E), respectively, over network 13. The server 11 runs administrative software for a computer network and controls access to itself and database 12. The remote device 15-20 may access the database 12 over a network 13, such as but not limited to: the Internet, a local area network (LAN), a wide area network (WAN), via a telephone line using a modem (POTS), Bluetooth, WiFi, cellular, optical, satellite, RF, Ethernet, magnetic induction, coax, RS-485, the like or other like networks. The server 11 may also be connected to the local area network (LAN) within an organization.

The remote device 15, 17-20 may each be located at remote sites. Remote device 15, 17-20 include but are not limited to, PCs, workstations, laptops, handheld computer, pocket PCs, PDAs, pagers, WAP devices, non-WAP devices, cell phones, palm devices, printing devices and the like.

Thus, when a user at one of the remote devices 15, 17-20 desires to access the browser objects from the database 12 at the server 11, the remote device 15, 17-20 communicates over the network 13, to access the server 11 and database 12.

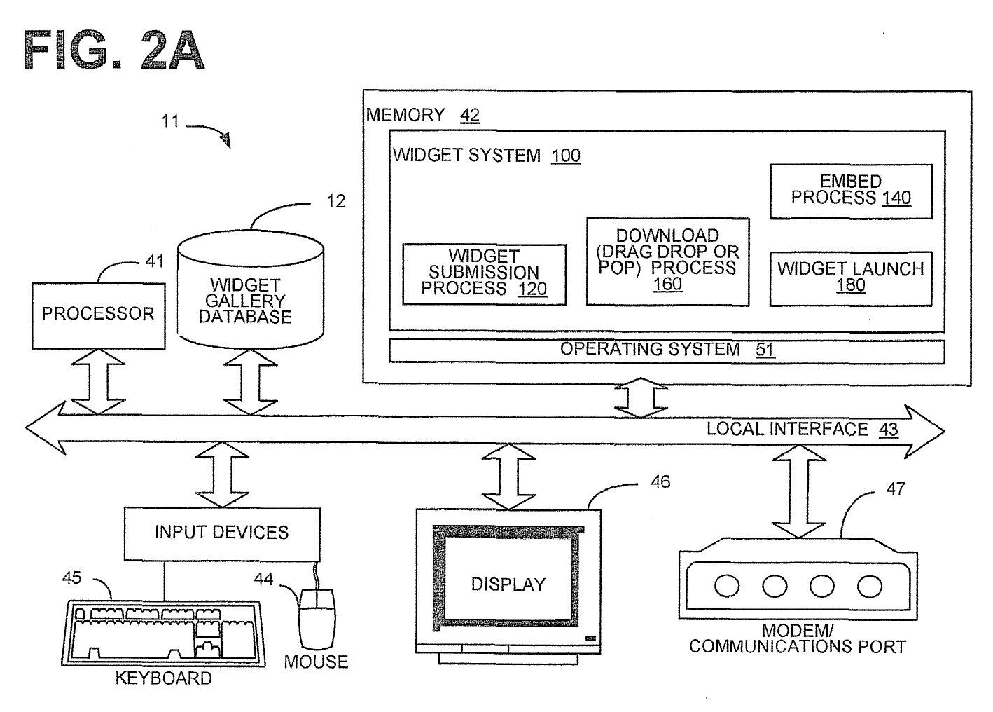

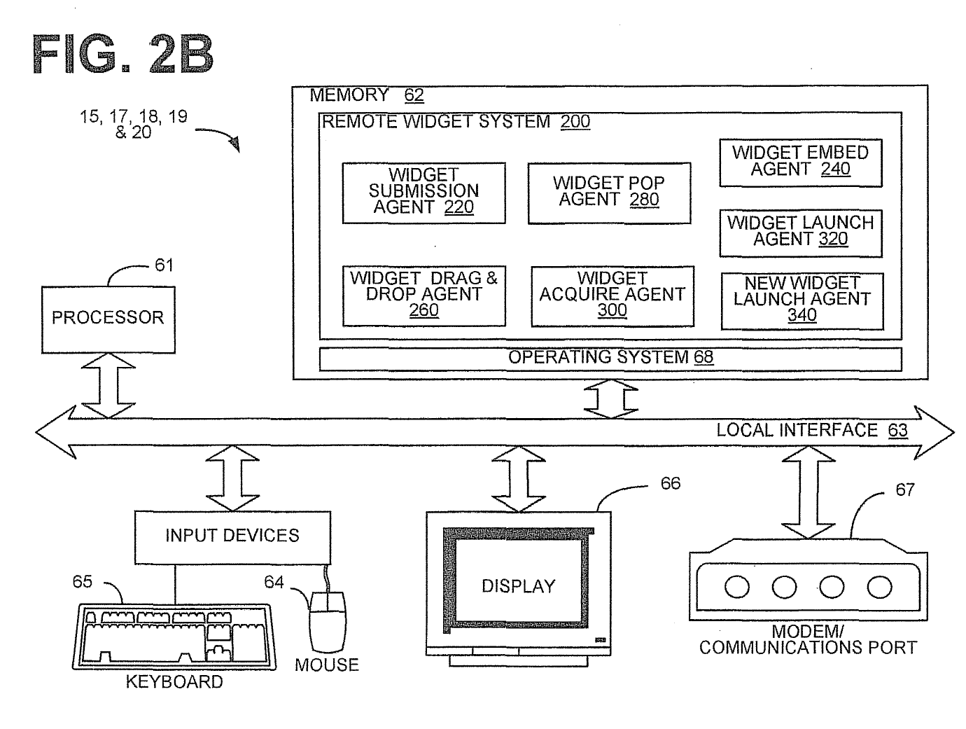

Illustrated in FIG. 2A is a block diagram demonstrating an example of server 11, as shown in FIG. 1, utilizing the widget system 100 of the present invention. Server 11 includes, but is not limited to, PCs, workstations, laptops, PDAs, palm devices and the like. Illustrated in FIG. 2B is an example demonstrating a remote devices 15 utilizing widget system 100 of the present invention. The processing components of the remote devices 15 are similar to that of the description for the server 11 (FIG. 2A).

Generally, in terms of hardware architecture, as shown in FIG. 2A, the server 11 include a processor 41, memory 42, and one or more input and/or output (I/O) devices (or peripherals) that are communicatively coupled via a local interface 43. The local interface 43 can be, for example but not limited to, one or more buses or other wired or wireless connections, as is known in the art. The local interface 43 may have additional elements, which are omitted for simplicity, such as controllers, buffers (caches), drivers, repeaters, and receivers, to enable communications. Further, the local interface 43 may include address, control, and/or data connections to enable appropriate communications among the aforementioned components.

The processor 41 is a hardware device for executing software that can be stored in memory 42. The processor 41 can be virtually any custom made or commercially available processor, a central processing unit (CPU), data signal processor (DSP) or an auxiliary processor among several processors associated with the server 11, and a semiconductor based microprocessor (in the form of a microchip) or a macroprocessor. Examples of suitable commercially available microprocessors are as follows: an 80x86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory 42 can include any one or combination of volatile memory elements (e.g., random access memory (RAM, such as dynamic random access memory (DRAM), static random access memory (SRAM), etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 42 may incorporate electronic, magnetic, optical, and/or other types of storage media. Note that the memory 42 can have a distributed architecture, where various components are situated remote from one another, but can be accessed by the processor 41.

The software in memory 42 may include one or more separate programs, each of which comprises an ordered listing of executable instructions for implementing logical functions. In the example illustrated in FIG. 2A, the software in the memory 42 includes a suitable operating system (O/S) 51 and the widget system 100 of the present invention. As illustrated, the widget system 100 of the present invention comprises numerous functional components including, but not limited to, the widget submission process 120, widget embed process 140 and download (i.e. drag/drop or pop) process 160.

A non-exhaustive list of examples of suitable commercially available operating systems 51 is as follows (a) a Windows operating system available from Microsoft Corporation; (b) a Netware operating system available from Novell, Inc.; (c) a Macintosh operating system available from Apple Computer, Inc.; (e) a UNIX operating system, which is available for purchase from many vendors, such as the Hewlett-Packard Company, Sun Microsystems, Inc., and AT&T Corporation; (d) a LINUX operating system, which is freeware that is readily available on the Internet; (e) a run time Vxworks operating system from WindRiver Systems, Inc.; or (f) an appliance-based operating system, such as that implemented in handheld computers or personal data assistants (PDAs) (e.g., Symbian OS available from Symbian, Inc., PalmOS available from Palm Computing, Inc., and Windows CE available from Microsoft Corporation).

The operating system 51 essentially controls the execution of other computer programs, such as the widget system 100, and provides scheduling, input-output control, file and data management, memory management, and communication control and related services. However, it is contemplated by the inventors that the widget system 100 of the present invention is applicable on all other commercially available operating systems.

The widget system 100 may be a source program, executable program (object code), script, or any other entity comprising a set of instructions to be performed. When a source program, then the program is usually translated via a compiler, assembler, interpreter, or the like, which may or may not be included within the memory 42, so as to operate properly in connection with the O/S 51. Furthermore, the widget system 100 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices may include input devices, for example but not limited to, a mouse 44, keyboard 45, scanner (not shown), microphone (not shown), etc. Furthermore, the I/O devices may also include output devices, for example but not limited to, a printer (not shown), display 46, etc. Finally, the I/O devices may further include devices that communicate both inputs and outputs, for instance but not limited to, a NIC or modulator/demodulator 47 (for accessing remote devices, other files, devices, systems, or a network), a radio frequency (RF) or other transceiver (not shown), a telephonic interface (not shown), a bridge (not shown), a router (not shown), etc.

If the server 11 is a PC, workstation, intelligent device or the like, the software in the memory 42 may further include a basic input output system (BIOS) (omitted for simplicity). The BIOS is a set of essential software routines that initialize and test hardware at startup, start the O/S 515 and support the transfer of data among the hardware devices. The BIOS is stored in some type of read-only-memory, such as ROM, PROM, EPROM, EEPROM or the like, so that the BIOS can be executed when the server 11 is activated.

When the server 11 are in operation, the processor 41 is configured to execute software stored within the memory 42, to communicate data to and from the memory 42, and to generally control operations of the server 11 are pursuant to the software. The widget system 100 and the O/S 51 are read, in whole or in part, by the processor 41, perhaps buffered within the processor 41, and then executed.

When the widget system 100 is implemented in software, as is shown in FIG. 2A, it should be noted that the widget system 100 can be stored on virtually any computer readable medium for use by or in connection with any computer related system or method. In the context of this document, a computer readable medium is an electronic, magnetic, optical, or other physical device or means that can contain or store a computer program for use by or in connection with a computer related system or method.

The widget system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system apparatus, device, or propagation medium.

More specific examples (a nonexhaustive list) of the computer-readable medium would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In an alternative embodiment, where the widget system 100 is implemented in hardware, the widget system 100 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Illustrated in FIG. 2B is a block diagram demonstrating an example of functional elements in the remote device 15, 17-20 that enables access to the widget system 100 of the present invention, as shown in FIG. 2A. The remote device 15 provides access to the widget or browser objects residing in database 12. The widgets or browser objects information accessed in database 12 can be provided in the number of different forms including but not limited to ASCII data, WEB page data (i.e. HTML), XML or other type of formatted data. As illustrated, the remote device 15, 17-20 includes many of the same components as server 11 described with regard to FIG. 2A. Hereinafter, the remote device 15, 17-20 is device that will be referred to as remote devices 15 for the sake of brevity.

Located in memory 62 of the remote device is remote widget system 200, which includes, but is not limited to, the widget submission agent 220, widget embed agent 240, widget drag drop agent 260, widget pop agent 280, widget acquire agent 300, widget launch agent 320 and new widget launch agent 340. When the remote widget system 200 is implemented in software, as is shown in FIG. 2B, it can be stored on virtually any computer readable medium for use by or in connection with any computer related system or method.

In an alternative embodiment, where the remote widget system 200 is implemented in hardware, the remote widget system 200 can be implemented in the same way as described above with regard to the widget system 100 (FIG. 2A).

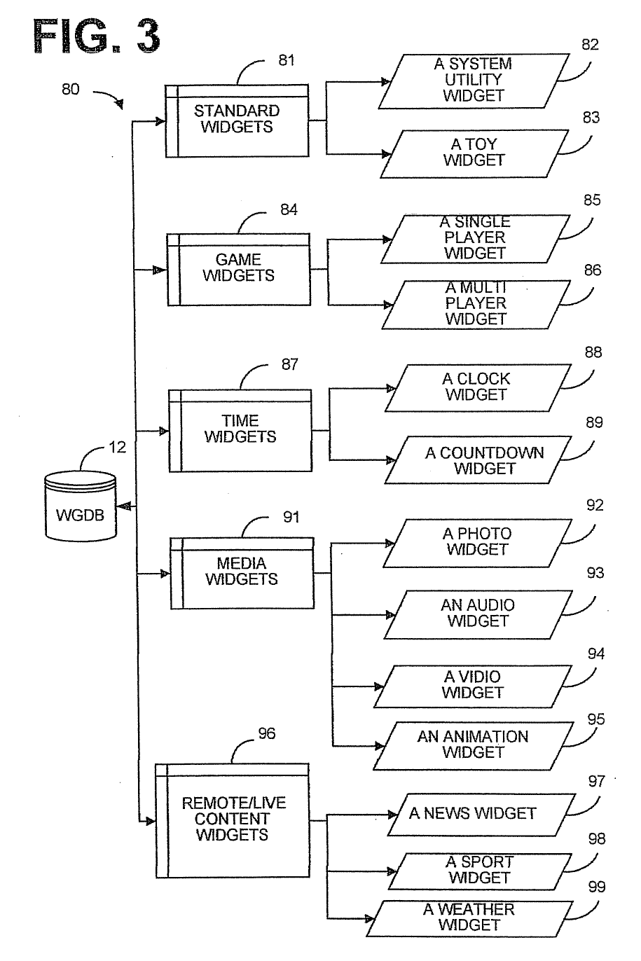

FIG. 3 is an example illustrating of the logical grouping of widget files in a database 12 and association of these files according to the widget system of the present invention, as shown in FIGS. 1, 2A and 2B. The database 12 comprises the widget database (WD) 80. The illustrated example WD 80 data comprises, but is not limited to, the groupings of standard 81, game 84, time 87, media 91 and remote/live content 96 widget types. These exemplary widget groupings furthering include exemplary subcategories, as follows. Standard widgets 81 include, but are not limited to, system utility widgets 82 and toy widgets 83. Game widgets 84 include, but are not limited to, single 85 and multiplayer 86 widgets. Time widgets 87 include, but are not limited to, clock widgets 88 and countdown to widgets 89. Media widgets 91, include, but are not limited to, photo 92, audio 93, video 94 and animation 95 widgets. And remote/live content widgets 96 include, but are not limited to, news widgets 97, sports widgets 98 and weather widgets 99.

As mentioned, the widget files are stored on the widget server(s), the data about the widgets is stored in database 12. When they are downloaded by the desktop widget wrapper the desktop widget wrapper creates a widget folder and stores the downloaded widget file in that folder. In the preferred embodiment, the downloaded widget files have the suffix “.sbw”, which stands for “.SpringBoxWidget”. These .sbw files are identical to the “.swf” files that a Flash Player runs, but they may contain ActionScript code referencing the widget API; code that is not recognized nor supported by a standard flash player and therefore would do nothing if not run inside the widget windows. Further the file extension allow the widget files to be linked to the desktop client thus, double-clicking on a widget file will launch the client to open it. The difference is not in terms of the programming code and the way that it is compiled, but in that the .sbw files are using remote API commands (RAPI) to extend the functions available in a Flash Player or clip. It is understood that other suffix indicating other types of widget files may be utilized.

Some RAPI commands used are: Widget.height, Widget.width, Widget.environment, and Widget.getParameters( ). The Widget.getParameters( ) command allows the widget to pull in the parameters that are inside the web page widget wrapper. There may be more API functions. Some could allow access to the hard drive, leverage features in the platform, or change the appearance of the widget wrapper (for ex ample, remove the close button that is part of the desktop wrapper).

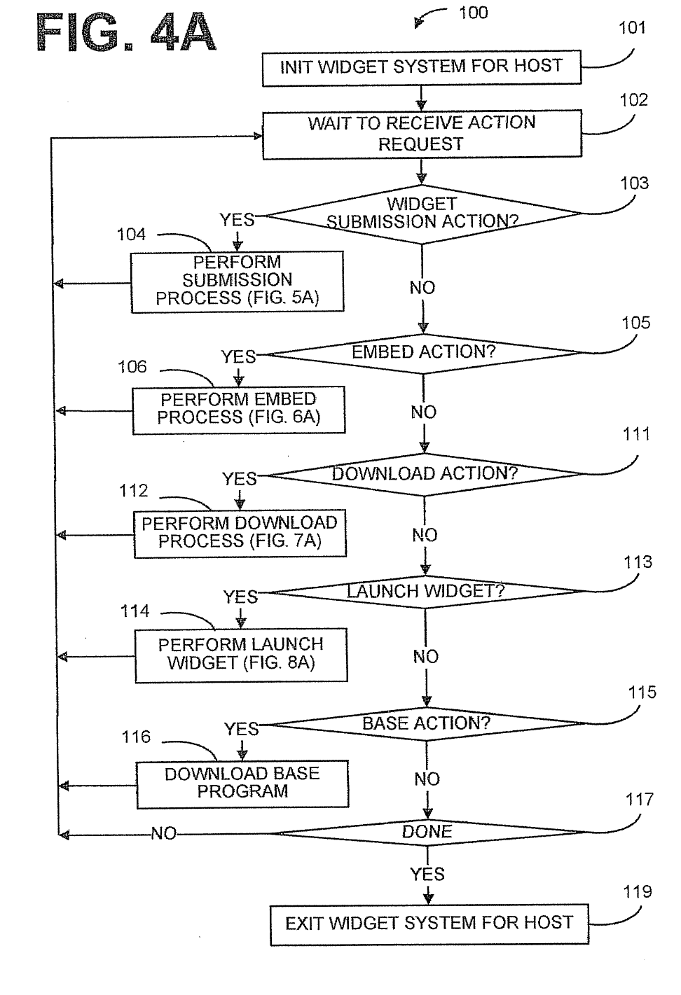

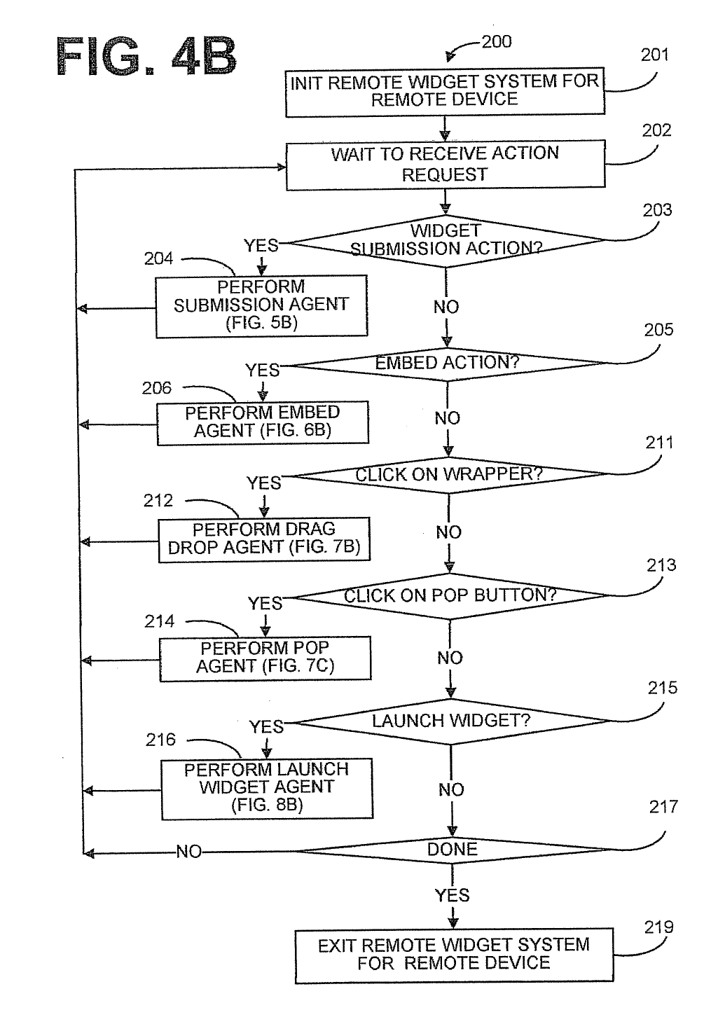

FIG. 4A is a flow chart illustrating an example of the operation of the widget system 100 of the present invention utilized by the server, as shown in FIGS. 2A-3. The widget system 100 of the present invention provides instructions and data in order to enable a user on a remote device to place widgets (i.e. browser objects) onto the desktop.

First at step 101, the widget system 100 is initialized. This initialization includes the startup routines and processes embedded in the BIOS of the server 11. The initialization also includes the establishment of data values for particular data structures utilized in the widget system 100.

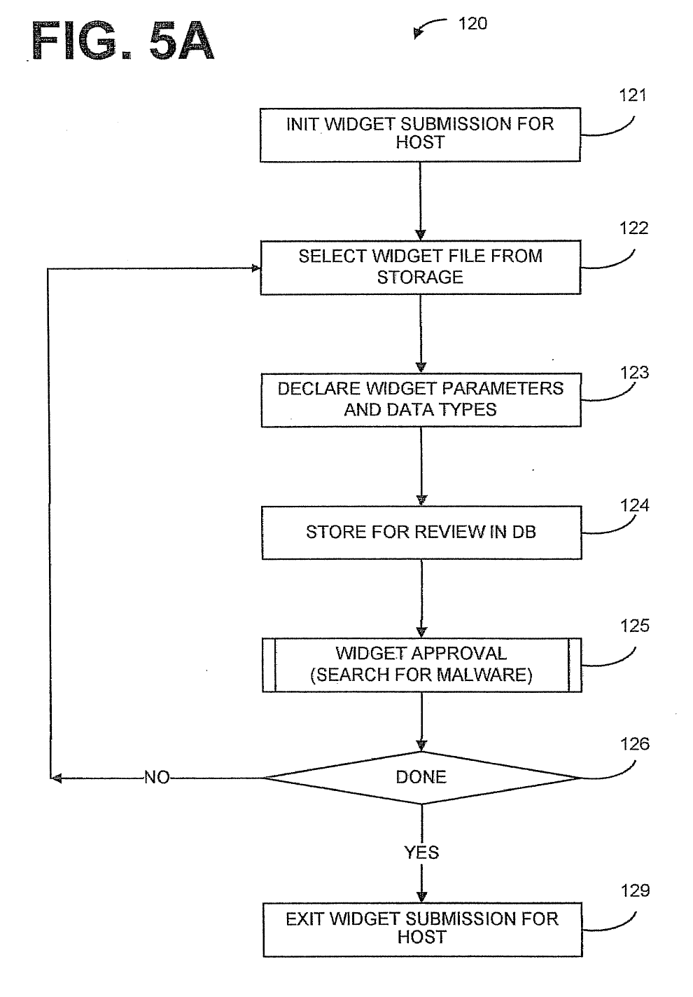

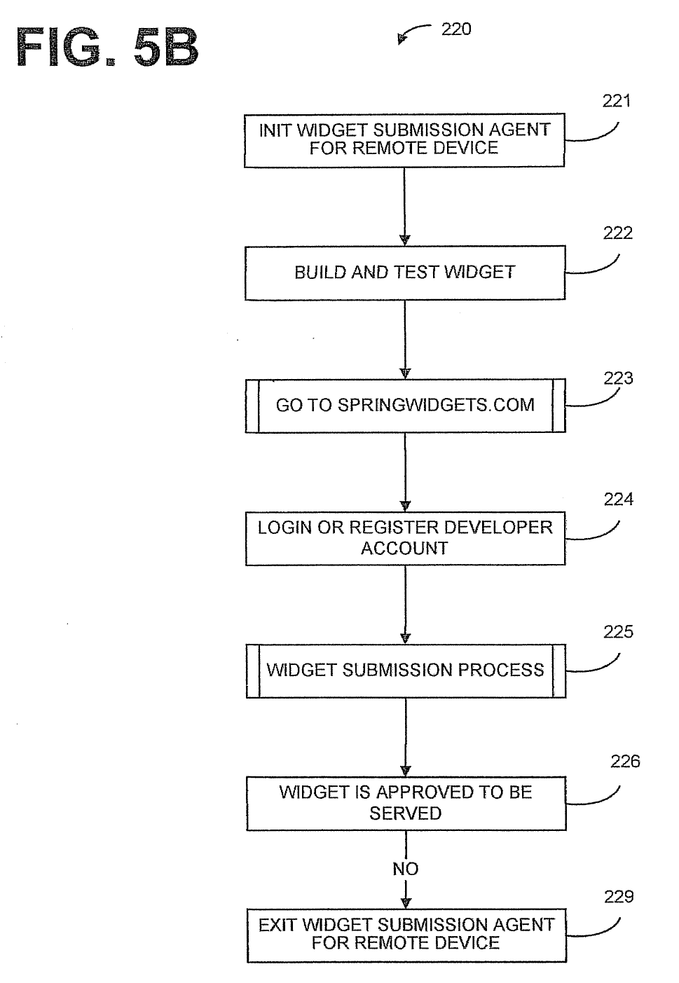

At step 102, the widget system 100 waits to receive an action request. After receiving an action request, the widget system 100 determines what type of action is being requested. At step 103, the widget system 100 determines if a widget submission action has been requested. A widget submission action is one where the user on a remote device 15 submits a widget for availability on server 11. If it is determined at step 103 that a widget submission action has not been requested, then the widget system 100 proceeds to step 105. However, if it is determined at step 103 that a widget submission action has been requested, then the submission process is performed at step 104. The submission process is herein defined in further detail with regard FIG. 5A.

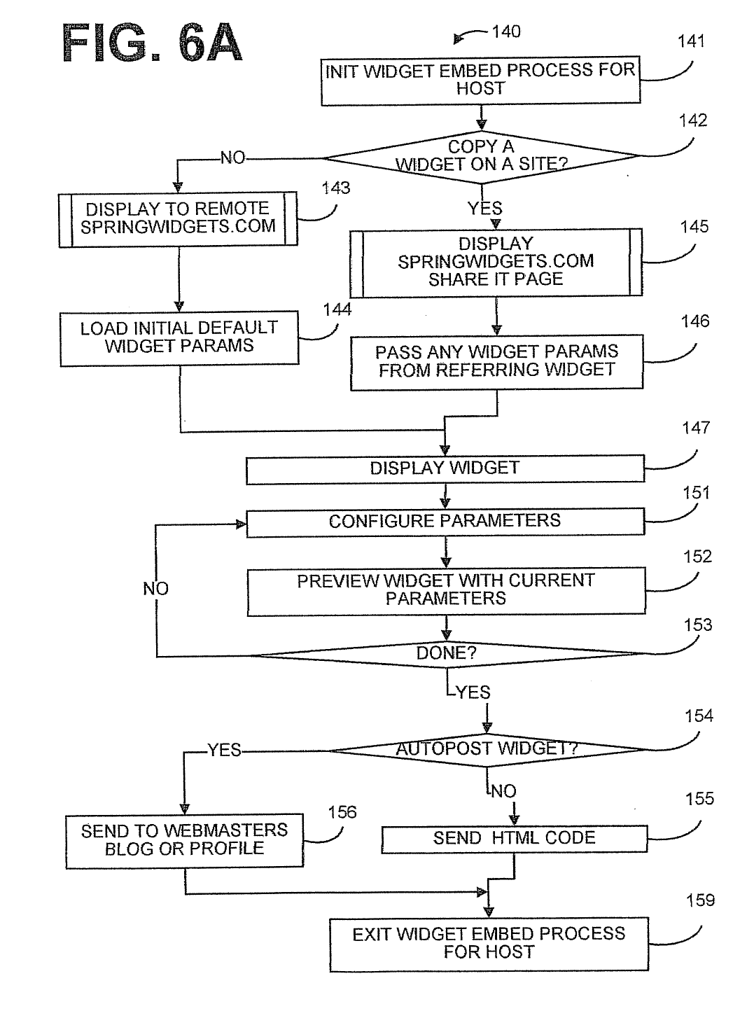

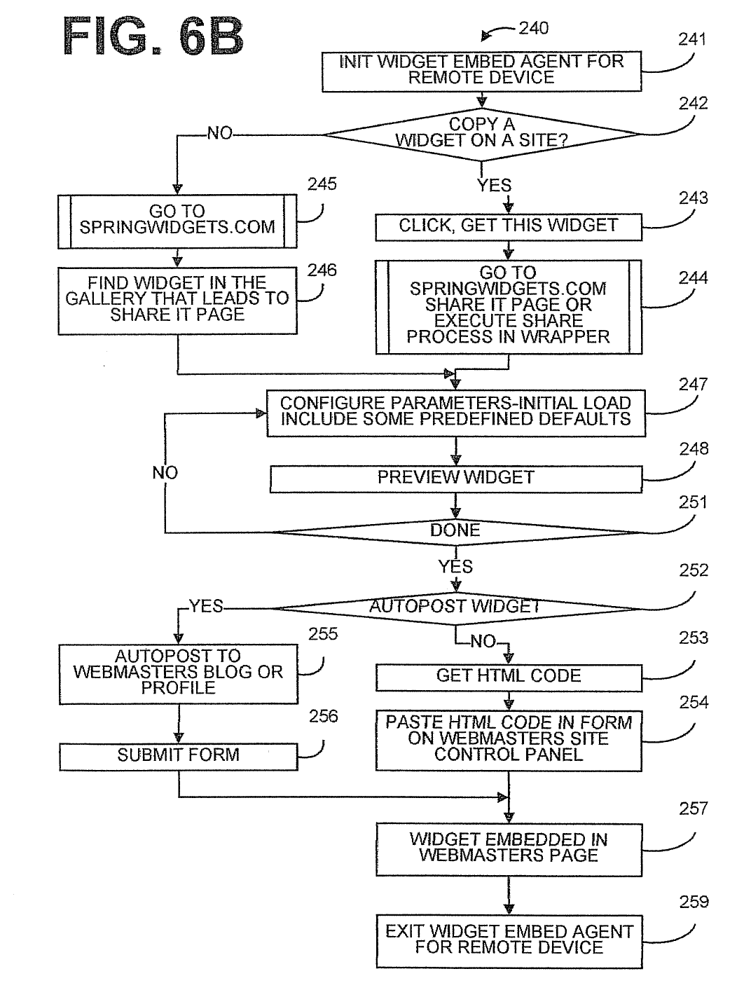

At step 105, the widget system 100 determines if a widget embed action has been requested. A widget embed action is one where a widget is found either on database 12 or on a third parties computers and the user wishes to place it on his desktop. If it is determined at step 105 that a widget embed action has not been requested, then the widget system 100 proceeds to step 111. However, if it is determined at step 105 that a widget embed action has been requested, then the widget embed process is performed at step 104. The widget embed process is herein defined in further detail with regard FIG. 6A.

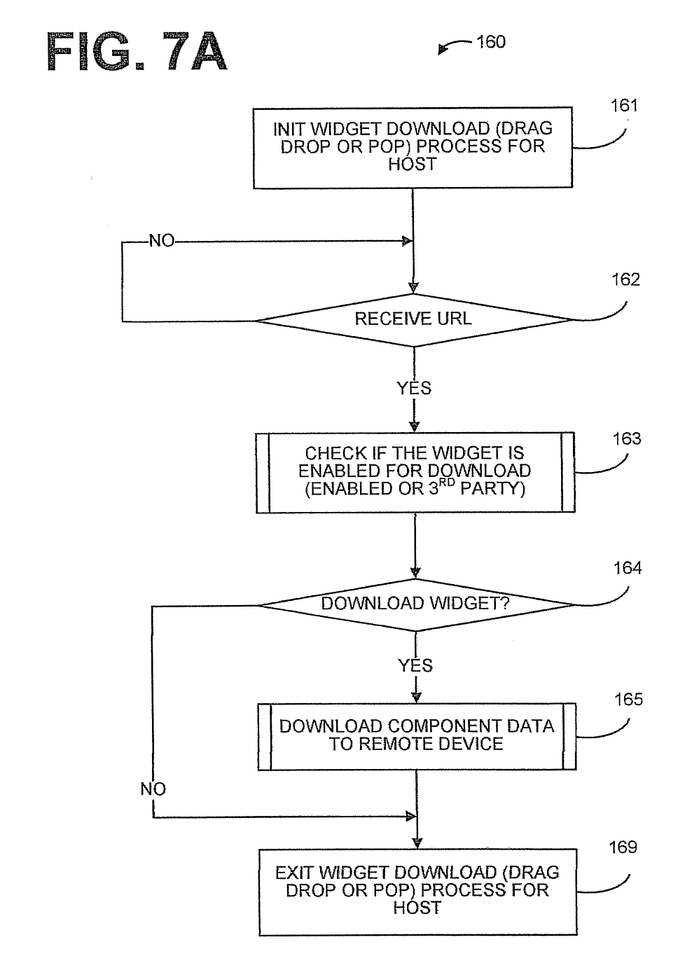

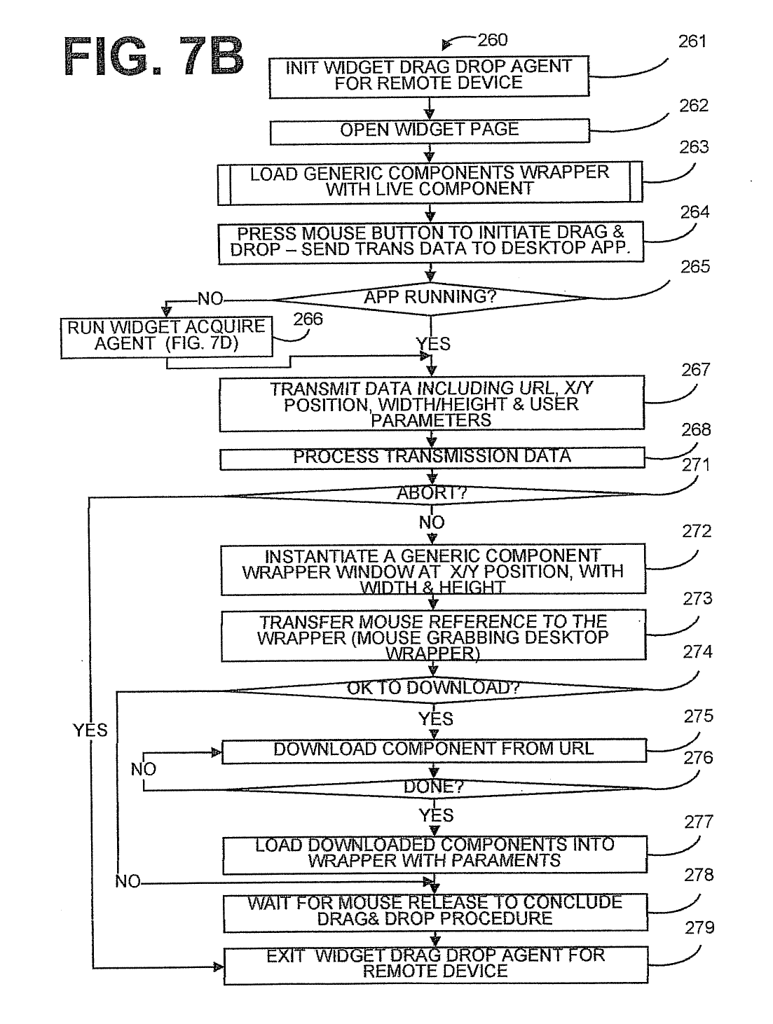

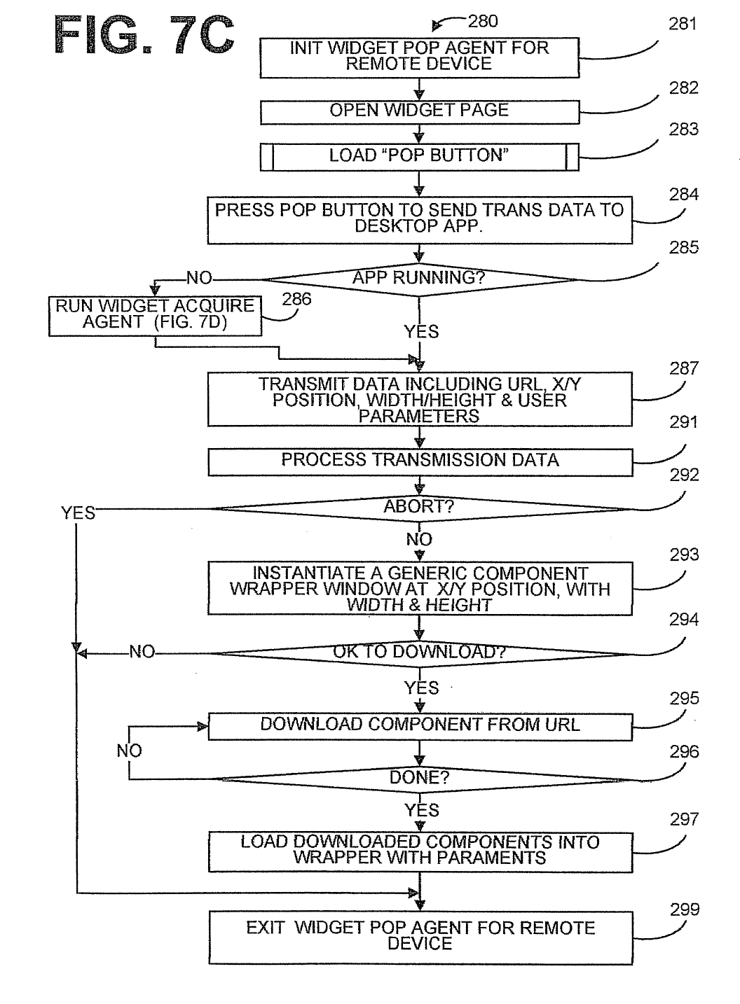

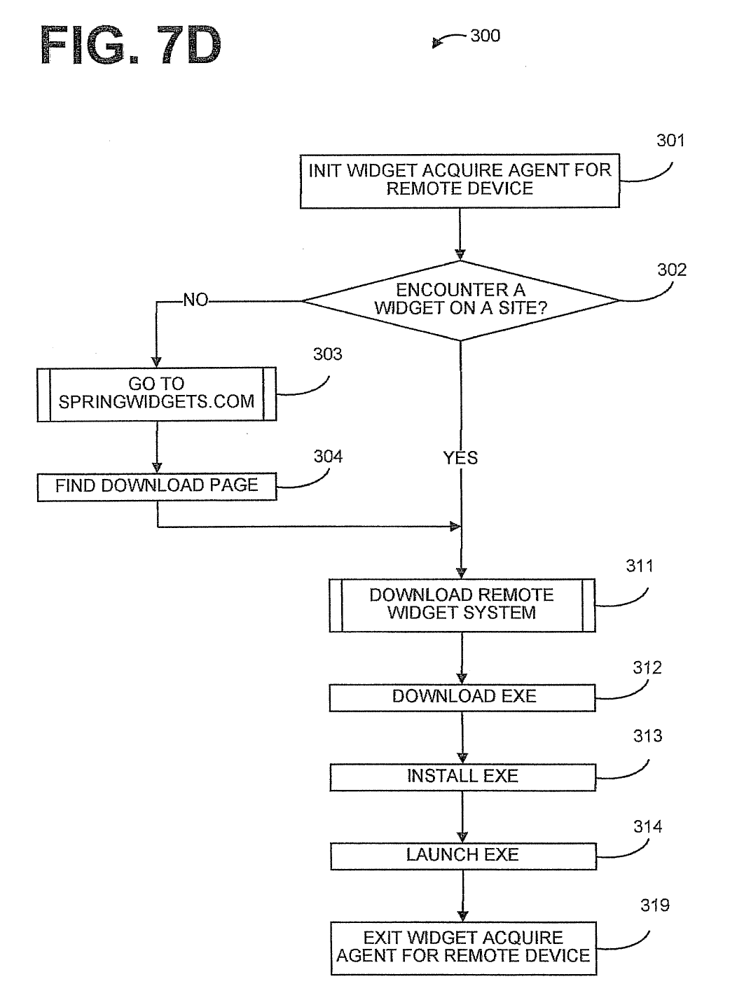

At step 111, the widget system 100 determines if a widget download action has been requested. A widget download action is one where widget system 100 receives a URL from a remote device 15 and downloads component data to the remote device 15. The URL received indicates, which particular widget components are downloaded. If it is determined at step 111 that a widget download action has not been requested, then the widget system 100 proceeds to step 113. However, if it is determined at step 111 that a widget download action has been requested, then the widget download process is performed at step 112. The widget download process is herein defined in further detail with regard FIG. 7A.

At step 113, the widget system 100 determines if a base action has been requested. A base action is one where widget system 100 receives a request from a remote device 15 and downloads base program (i.e. remote widget system 200) to the remote device 15. If it is determined at step 113 that a base action has not been requested, then the widget system 100 proceeds to step 115. However, if it is determined at step 113 that a base action has been requested, then the download base process is performed at step 114. In one embodiment, a list of allowed domains is preconfigured in the remote widget system 200 when loaded onto the remote device 15.

At step 115, it is determined if the widget system 100 is to wait for additional action request. If it is determined at step 115 that the widget system is to wait to receive additional actions, then the widget system 100 returns to repeat steps 102 through 115. However, if it is determined at step 115 that there are no more actions to be received, then the widget system 100 then exits at step 119.

FIG. 4B is a flow chart illustrating an example of the operation of the remote widget system 200 of the present invention utilized by the remote device 15, as shown in FIG. 2B. The remote widget system 200 enables a widget wrapper or browser object to function on the user remote device 15. The remote widget system 200 may be installed by any convenient method for example, but not limited to a disk or by downloading off a network. If the remote widget system 200 is not installed and operational when a user attempts to place a browser object or widget on the desktop, then the user will be prompted to download and install the remote widget system 200 on the remote device 15. In the illustrated example, this installation happens inside the wrapper rather than pointer to a page on the server 11. However, other methods of performing this task can be utilized including, but not limited to, pointing the user to a download page, download the file, silent install many options here depending on the OS.

First at step 201, the remote widget system 200 is initialized. This initialization includes the startup routines and processes embedded in the BIOS of the remote device 15. The initialization also includes the establishment of data values for particular data structures utilized in the remote widget system 20.

At step 202, the remote widget system 200 waits to receive an action request. After receiving an action request, the remote widget system 200 determines what type of action is being requested. At step 203, the remote widget system 200 determines if a widget submission action has occurred. A widget submission action is one where the user on a remote device 15 submits a widget for availability on server 11. If it is determined at step 203 that a widget submission action has not occurred, then the remote widget system 200 proceeds to step 205. However, if it is determined at step 203 that a widget submission action has occurred, then the submission agent is performed at step 204. The submission agent is herein defined in further detail with regard FIG. 5B.

At step 205, the remote widget system 200 determines if a widget embed action has occurred. A widget embed action is one where a widget is found either on database 12 or on a third parties computers and the user wishes to place it on his desktop. If it is determined at step 205 that a widget embed action has not occurred, then the remote widget system 200 proceeds to step 211. However, if it is determined at step 205 that a widget embed action has occurred, then the embed agent is performed at step 204. The embed agent is herein defined in further detail with regard FIG. 6B.

At step 211, the remote widget system 200 determines if a widget or wrapper has been clicked upon and held action to initiate a drag and drop operation. A drag and drop action is one where a user, for example, presses and holds a left mouse button on a widget or wrapper component to initiate drag-and-drop operation. A URL is sent to the widget system 100 on server 11 to acquire particular widget components that are then downloaded. If it is determined at step 211 that a widget drag and drop action has not occurred, then the remote widget system 200 proceeds to step 213. However, if it is determined at step 211 that a widget drag and drop action has occurred, then the drag-and-drop agent is performed at step 212. The drag-and-drop agent is herein defined in further detail with regard FIG. 7B.

At step 213, the remote widget system 200 determines if a widget or wrapper has been popped to initiate a pop operation. A pop action is one where a user, for example, presses a pop button on a widget or wrapper component to initiate a pop operation. A URL is sent to the widget system 100 on server 11 to acquire particular widget components that are downloaded. If it is determined at step 213 that a widget pop action has not occurred, then the remote widget system 200 proceeds to step 215. However, if it is determined at step 213 that a widget pop action has occurred, then the pop agent is performed at step 214. The pop agent is herein defined in further detail with regard FIG. 7C.

At step 215, it is determined if the remote widget system 200 is to wait for additional action request. If it is determined at step 215 that the remote widget system 200 is to wait to receive additional actions, then the remote widget system 200 returns to repeat steps 202 through 215. However, if it is determined at step 215 that there are no more actions to be received, then the remote widget system 200 then exits at step 219.

FIG. 5A is a flow chart illustrating an example of the operation of the widget submission process 120 on the server 11 that is utilized in the widget system 100 of the present invention, as shown in FIGS. 2A and 4A. The widget submission process 120 enables the creation of a widget in storage of that widget in database 12. Once the widget is placed in server 11, it is available for other third-party users. A brief overview of one exemplary process is as follows: 1) is user registered and logged in, if not, require login and/or developer registration; 2) upload files from local machine; 3) Validate and store widget name and meta information; 4) declare widget parameters and data-types; 5) store for review; 6) widget approval; and 7) done.

First at step 121, the widget submission process 120 is initialized. This initialization includes the startup routines and processes embedded in the BIOS of the server 11. The initialization also includes the establishment of data values for particular data structures utilized in the widget submission process 120.

At step 122, the widget submission process 120 enables the selection. At step 123, the widget parameters and data types are declared. At step 124, the widget file is stored in a protected folder on the server 11 and its associated information is stored in the database 12 for further review. At step 125, the widget is reviewed and approved. This approval is performed as a search for errors that includes, but is not limited to viruses or malware. Moreover, this review approval process can be automated or through human review. Upon approval the file is moved to a publicly accessible folder and is made visible in the gallery.

At step 126, the widget submission process 120 determines if there are more widgets to be submitted. It is determined to step 126 that there are more widgets to be submitted, then the widget submission process 120 returns to repeat steps 122 through 126. Otherwise, the widget submission process 120 then exits at step 129

FIG. 5B is a flow chart illustrating an example of the operation of the widget submission agent 220 on the remote device 15 that is utilized in the remote widget system 200 of the present invention, as shown in FIGS. 2B and 4B.

First at step 221, the widget submission agent 220 is initialized. This initialization includes the startup routines and processes embedded in the BIOS of the remote device 15. The initialization also includes the establishment of data values for particular data structures utilized in the widget submission agent 220.

At step 222, the widget submission agent 220 enables a user to select, build and test a widget. Upon the selection of the build and test functionality at step 222, the widget submission agent 220 then proceeds to a widget provider website at step 223. While in the exemplary embodiment utilizes the Internet, other networks are appropriate.

At step 224, the widget submission agent 220 requests that the user login or register their developer account. At step 225, the widget submission agent 220 interacts with the widget submission process 120 on server 11. At step 226, the widget is approved to be served from the server 11. Once the widget is approved, at step 125 in the widget submission process 120, the widget appears in gallery on the widget provider, such as for example, the springwidgets.com website. The widget submission agent 220 then exits at step 229.

FIG. 6A is a flow chart illustrating an example of the operation of the widget embed process 140 on the server 11 that is utilized in the widget system 100 of the present invention, as shown in FIGS. 2A and 4A. The embed process 140 is utilized in order to embed a widget on a user remote device desktop.

First at step 141, the widget embed process 140 is initialized. This initialization includes the startup routines and processes embedded in the BIOS of the server 11. The initialization also includes the establishment of data values for particular data structures utilized in the widget embed process 140.

At step 142, the widget embed process 140 determines if the requested action is to copy a widget on a site. If it is determined that the selected action is to copy a widget on a site, then the widget embed process 140 displays the widget providers site in order to download the widget at step 143. In the exemplary embodiment, the widget provider is springwidgets.com and the component display the widget is Share-it-Page. At step 144, the widget embed process 140 loads the initial default widget parameters. The default widget parameters include, but are not limited to, presentation, state and session parameters. The widget in that process 140 then proceeds to step 147.

However, if it is determined at step 142 that the selected action is not to copy a widget on a site, then the widget embed process 140 displays to the remote device 15 the springwidget.com website, at step 145. Then at step 146, the widget embed process 140 passes any widget parameters from the referring widget.

At step 147, the widget is displayed on the remote device 15. At step 151, the widget embed process 140 then configures parameters for a selected widget. The configuration of parameters at step 151 includes manipulation of presentation, state and session parameters as permitted. At step 152, the widget with the current parameters is sent to the remote device for review.

At step 153, it is determined if the user on a remote device 15 wishes to change current parameters. If it is determined at step 153 that the user is making changes to the parameters, then the widget embed process 140 returns to repeat steps 151 through 153. However, if it is determined at step 153 that the current parameters for the widget are satisfactory, then the widget embed process 140 determines at step 154 if the widget is to be autoposted onto a site.

If it is determined at step 154 that the widget is to be autoposted to a user's desktop, then the HTML code is sent to the user on the remote device 15 at step 155. However, if it is determined that the widget is not to be pasted at step 154, then the widget embed process 140 sends the widget and current parameters to a Webmasters blog or profile at step 156.

The widget embed process 140 then exits at step 159.

FIG. 6B is a flow chart illustrating an example of the operation of the widget embed agent 240 on the remote device 15 that is utilized in the remote widget system 200 of the present invention, as shown in FIGS. 2B and 4B. The widget embed agent 240 provides the capability for a user a remote device 15 to embed a widget on a blog profile or a desktop such as the control panel.

First at step 241, the widget embed agent 240 is initialized. This initialization includes the startup routines and processes embedded in the BIOS of the remote device 15. The initialization also includes the establishment of data values for particular data structures utilized in the widget embed agent 240.

At step 242, the widget embed agent 240 determines if the requested action is to copy a widget on a site. If it is determined that the selected action by the user is to copy a widget on a site, Then the widget embed agent 240 gets this widget by clicking “get this widget” at step 243. At step 244, the widget embed agent 240 goes to the widget providers download page Share-it-Page or executes a shared process in the wrapper. This is accomplished by acquiring the parameters from the referenced widget. In the preferred embodiment, the widget provider is springwidget.com and the download page is the Share-it-Page.

However, if it is determined that the selected action is not to copy a widget on a site, then the widget embed agent 240 requests going to the springwidgets.com website at step 245. The widget embed agent 240 displays the springwidget.com website gallery. At step 246, the widget embed agent 240 then enables a user to find and select a widget in the gallery.

At step 247, the widget embed agent 240 then enables the user to configure parameters for a selected widget. The configuration of parameters at step 247 includes the initial load of some predefined defaults for a widget. At step 248, the widget's current parameters are displayed on the remote device 15 for review.

At step 251, it is determined if the user wishes to change current parameters. If it is determined at step 251 that the user is making changes to the parameters, then the widget embed agent 240 returns to repeat steps 247 through 251. However, if it is determined at step 251 that the current parameters for the widget are satisfactory, then the widget embed agent 240 determines at step 252 if the user wants to autopost the widget onto a site.

If it is determined at step 252 that the widget is to be autoposted to a user's desktop, then the HTML code is acquired at step 253. The HTML code is then pasted into a form on the Webmasters site control panel at step 254. However, if it is determined that the widget is not to be pasted at step 252, then the widget embed agent 240 autoposts the widget and current parameters to a Webmasters blog or profile at step 255 and submits the form at step 256.

At step 257, the widget is embedded in the Webmasters page. The widget embed agent 240 then exits at step 259.

FIG. 7A is a flow chart illustrating an example of the download process 160 on the server 11 that is utilized in the widget system 100 of the present invention, as shown in FIGS. 2A and 4A. The download process 160 on server 11 allows the widget system 100 of the present invention to download component data to the remote device 15.

First at step 161, the download process 160 is initialized. This initialization includes the startup routines and processes embedded in the BIOS of the server 11. The initialization also includes the establishment of data values for particular data structures utilized in the download process 160. At step 162, the download process 160 waits to receive a URL.

At step 163, the widget download process 160 checks to see if the widget is enabled for download and the source of the widget. If the widget is not enabled for download, the user is notified. If the source of the widget is a third party, the user is also notified of this situation and asked if the download is to continue.

At step 164, it is determined user has indicated that the download is to continue. If it is indicated that the download is not to continue, then the widget download process 160 skips to step 169. However, if it is determined at step 164 that the download is to continue, then at step 165 the widget download process 160 downloads component data to the remote device 15 corresponding to the received URL.

Widget file is downloaded from server 11 to the remote device 15. In addition, the widget parameters are passed from the web wrapper to the new instance of the widget on the desktop. The widget is then instantiated with these parameters on the remote device 15. These parameters include, but are not limited to, user, state and widget session parameters. Session data being data that was input in the current instance of the widget. User data can be data defined by the creator of the widget and data added by the user. State data includes, but is not limited to, data that describes the widget, such as but not limited to, tabs, views, display modes, and the like.

In an alternative embodiment, allowed domains are updated any time widget data is downloaded from server 11. In another alternative embodiment, the allowed domains are updated by being downloaded from the widget system 100 on server 11 at each start of the remote widget system 200 on the remote device 15. In still another alternative embodiment, the allowed domains are updated any time the remote widget system 200 requests the latest allowed domain from the widget system 100 on server 11. In another alternative embodiment, the remote widget system 200 may send a request to widget system 100 to validate a specific domain.

The download process 160 then exits at step 169.

FIG. 7B is a flow chart illustrating an example of the operation of the drag drop agent 260 on the remote device 15 that is utilized in the remote widget system 200 of the present invention, as shown in FIGS. 2B and 4B. The drag drop agent 260 on remote device 15 allows the remote widget system 200 of the present invention to drag and drop widget component data onto the remote device 15.

First at step 261, the drag drop agent 260 is initialized. This initialization includes the startup routines and processes embedded in the BIOS of the remote device 15. The initialization also includes the establishment of data values for particular data structures utilized in the drag drop agent 260.

At step 262, the drag drop agent 260 opens a widget page and loads generic components wrapper would live components at step 263. At step 264, in the exemplary embodiment, a mouse button is pressed, but not released, to initiate the drag and drop functionality. This operation sends transmission data to the desktop application.

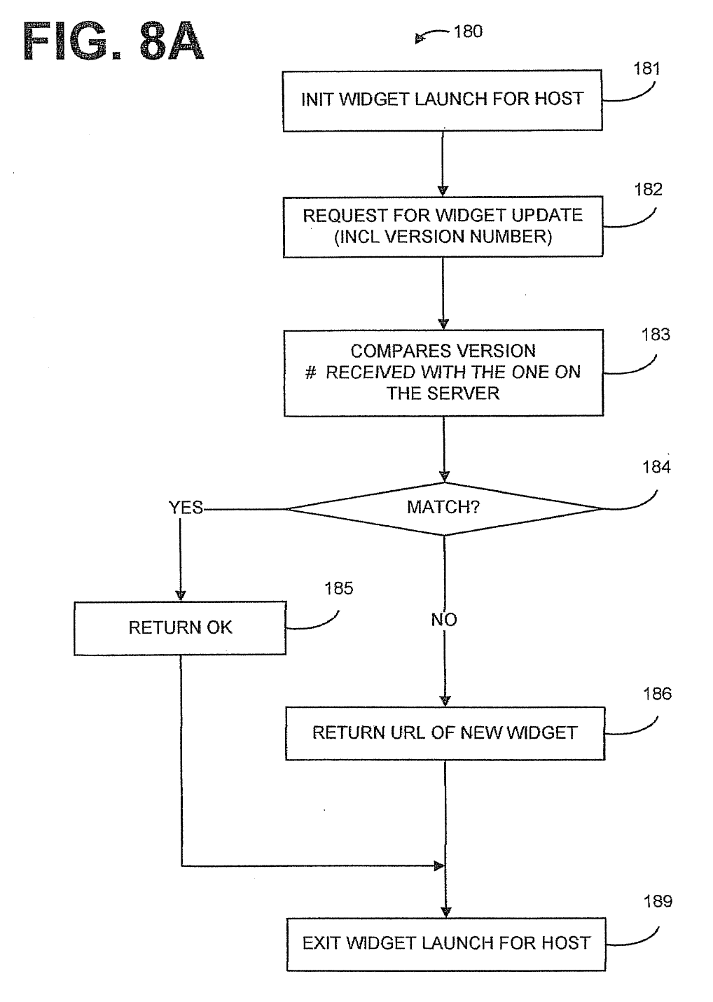

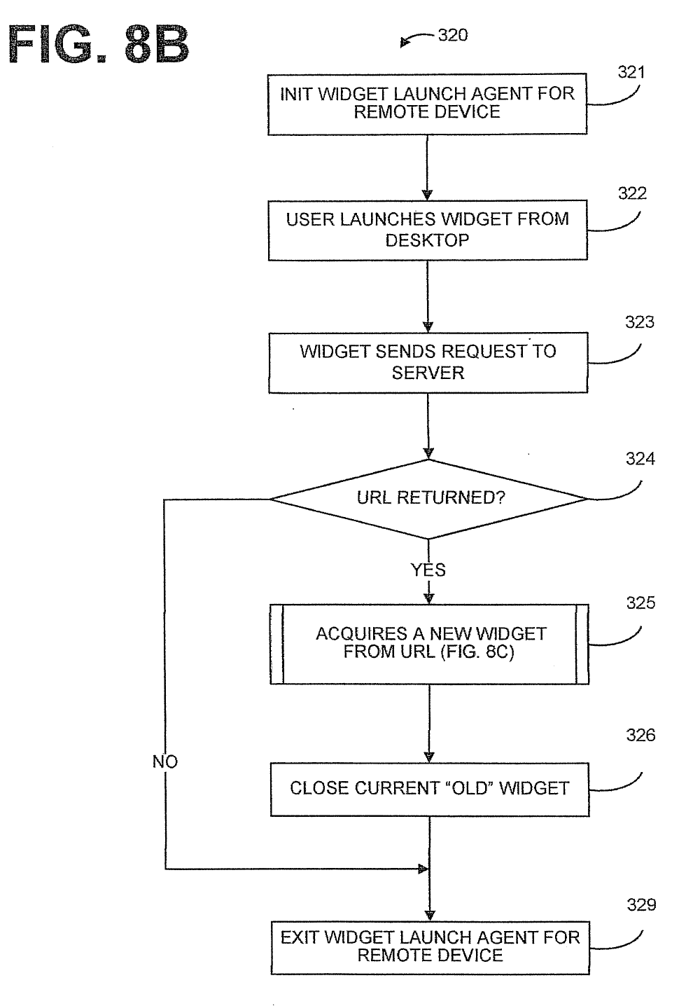

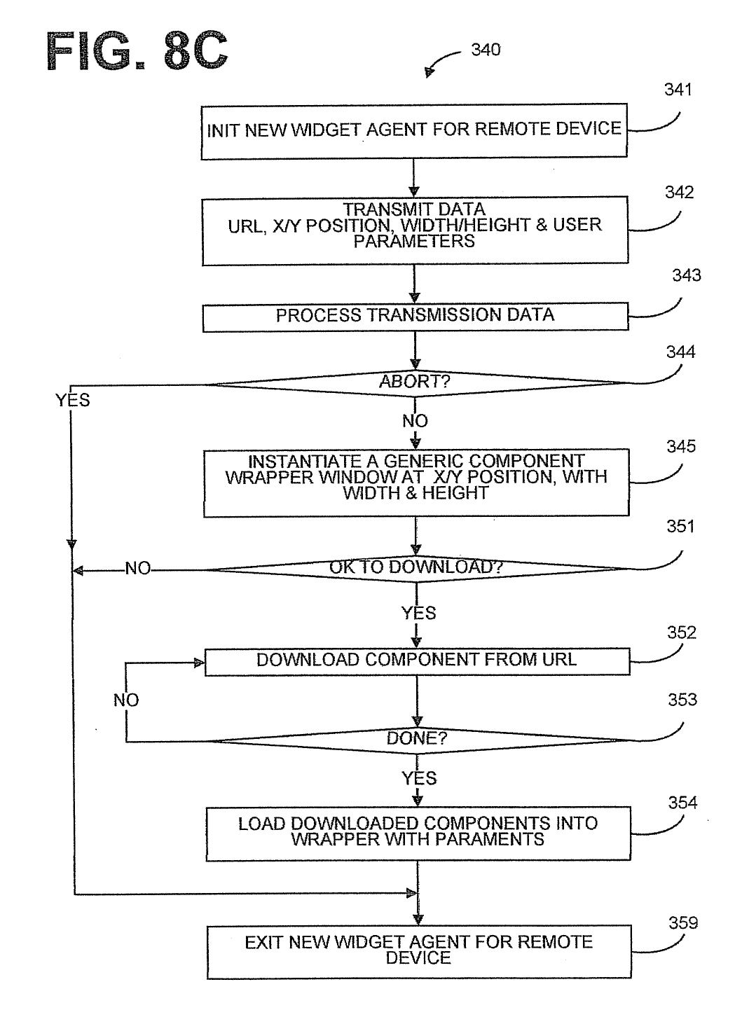

At step 265, the widget drag drop agent 260 determines if the remote widget system 200 application is running. It is determined at step 265 that the remote widget system 200 (i.e. application) is running, then the widget drag drop agent 260 proceeds to step 267. However, if it is determined at step 265 that the remote widget system 200 is not running, then the widget acquire agent is run at step 266. The widget acquire agent downloads the remote widget system 200 to remote device 15. The widget acquire agent as herein defined for further detail with regard to FIG. 8.

At step 267, the widget drag drop agent 260 transmits data including the URL, X/Y position for the widget, the width and height, and other user or system platform parameters to the widget system 100 on server 11. The user parameters include anything that applies to the widget configuration that the user can set or modify. System parameters include, but are not limited to, tracking, partner IDs, widget instance IDs, and the like.

At step 268, the widget drag drop agent 260 waits to receive transmission data and processes that data once received. Processing of the data includes preprocessing and validation of the widget parameters. The preprocessing and validation includes, but is not limited to, checking if the URL is from an allowed domain, verify that the X/Y position of the widget is located in a viable display space of the screen, process the past parameters to initialize the widget state, and the like. At step 271, the widget pop agent 280 checks the domain of the widget URL in the data received. If the domain of the widget data received is not from an allowed domain, the process is aborted and proceeds to step 279.

In an alternative embodiment, allowed domains are updated any time widget data is downloaded from server 11. In another alternative embodiment, the allowed domains are updated by being downloaded from the widget system 100 on server 11 at each start of the remote widget system 200 on the remote device 15. In still another alternative embodiment, the allowed domains are updated any time the remote widget system 200 requests the latest allowed domain from the widget system 100 on server 11. In another alternative embodiment, the remote widget system 200 may send a request to widget system 100 to validate a specific domain.

At step 272, the drag drop agent 260 then instantiates a generic component wrapper window with the X/Y position, height and width, and user parameters as defined at step 264. User parameters include, but not limited to, the state of the widget, user data, and session data. The mouse reference to the wrapper is then transferred at step 273. The reference is the mouse grabbing desktop wrapper.

At step 274, the user receives a message telling the user if the widget is not enabled, or if it's a non-trusted widget. A non-trusted widget would be a widget that was supplied by a third party. If the widget is not enabled, or it the user decides not to download a non-trusted widget, then the widget drag drop agent 260 proceeds to step 277.

At step 276, the drag drop agent 260 then downloads component from the URL. At step 276, it is determined if there are more components be downloaded from the URL. If it is determined at step 276 that there are more components to be downloaded, and the widget drag drop agent 260 returns to repeat steps 273-276. However, if it is determined in step 276 that there are no more components to be downloaded, then the widget drag drop agent 260 loads the downloaded components into a widget wrapper with the defined parameters at step 277. Loading the components executes the new widget on the remote device 15.

At step 278, the drag drop agent 260 then waits for the mouse released to conclude the drag and drop procedure. It is understood that other indications for dragging and dropping a widget can be utilized such as a touchpad or joystick button. At step 279, the drag drop agent 260 then exits.

FIG. 7C is a flow chart illustrating an example of the operation of the widget pop agent 280 on the remote device 15 that is utilized in the remote widget system 200 of the present invention, as shown in FIGS. 2B and 4B. The widget pop agent 280 enables a remote user the ability to pop a widget onto a remote device 15 desktop.

First at step 281, the widget pop agent 280 is initialized. This initialization includes the startup routines and processes embedded in the BIOS of the remote device 15. The initialization also includes the establishment of data values for particular data structures utilized in the widget pop agent 280.

At step 282, the widget pop agent 280 opens a widget page and loads a pop button at step 283. When this pop button is clicked (i.e. pressed and immediately released), at step 284, operation sends transmission data to the desktop application. At step 285, it is determined that the remote widget system 200 (i.e. application) is currently running on the remote device 15. It is determined at step 285 that the remote widget 200 is running on the remote device 15, then the widget pop agent to 80 proceeds to step 267. However, it is determined at step 265 that the remote widget system 200 is not operating, then the widget acquire agent is executed at step 286. The widget acquire agent enables the remote device 15 to acquire the remote widget system 200. The widget acquire agent is herein defined in further detail with regard to FIG. 8.

At step 287, the widget pop agent 280 transmits data including the URL, X/Y position for the widget, the width and height, and user & system platform parameters to the widget system 100 on server 11. The user parameters include anything that applies to the widget configuration that the user can set or modify. System parameters include, but are not limited to, tracking, partner IDs, widget instance IDs, and the like.

At step 291, the widget pop agent 280 waits to receive transmission data and processes that data once received. Processing of the data includes preprocessing and validation of the widget parameters. The preprocessing and validation includes, but is not limited to, checking if the URL is from an allowed domain, verify that the X/Y position of the widget is located in a viable display space of the screen, process the past parameters to initialize the widget state, and the like.

At step 292, the widget pop agent 280 checks the domain of the widget URL in the data received. If the domain of the widget data received is not from an allowed domain, the process is aborted and proceeds to step 299.

In an alternative embodiment, allowed domains are updated any time widget data is downloaded from server 11. In another alternative embodiment, the allowed domains are updated by being downloaded from the widget system 100 on server 11 at each start of the remote widget system 200 on the remote device 15. In still another alternative embodiment, the allowed domains are updated any time the remote widget system 200 requests the latest allowed domain from the widget system 100 on server 11. In another alternative embodiment, the remote widget system 200 may send a request to widget system 100 to validate a specific domain.

At step 293, the widget pop agent 280 then instantiates a generic component wrapper window with the X/Y position, height and width, and parameters as defined at step 284. A step 294, the user receives a message telling the user if the widget is not enabled, or if it's a non-trusted widget. A non-trusted widget would be a widget that was supplied by a third party. If the widget is not enabled, or it the user decides not to download a non-trusted widget, then the widget pop agent 280 proceeds to step 299.

A step 295, the widget pop agent 280 then downloads component from the URL. At step 296, it is determined if there are more components be downloaded from the URL. If it is determined at step 296 that there are more components to be downloaded, and the widget pop agent 280 returns to repeat steps 295 and 296. However, it is determined in step 296 that there are no more components to be downloaded, then the widget pop agent 280 then loads the downloaded components into a widget wrapper with the defined parameters at step 297. Loading the components executes the new widget on the remote device 15. At 299, the widget pop agent 280 then exits.

FIG. 7D is a flow chart illustrating an example of the operation of the widget acquire agent 300 on the remote device 15 that is utilized to download the remote widget system 200 of the present invention, as shown in FIGS. 2A and 2B. the widget acquire agent 300 enables a user on a remote device 15 to acquire the remote widget system 200 of the present invention in order to enable the processing of widgets.

First at step 301, the widget acquire agent 300 is initialized. This initialization includes the startup routines and processes embedded in the BIOS of the remote device 15. The initialization also includes the establishment of data values for particular data structures utilized in the widget acquire agent 300.

At step 3025 the widget acquire agent 300 determines if the action encounters widget on a site. If it is determined that the action by the user did encounter a widget on a site. Then the widget acquire agent 300 proceeds to step 311. However, if it is determined that the action is not to encounter a widget on a site, then the widget acquire agent 300 requests going to the springwidgets.com website at step 303. The widget acquire agent 300 displays the springwidgets.com website. At step 304, the widget acquire agent 300 then enables a user to find the download page.

At step 311, the widget acquire agent 300 downloads the remote widget system 200. At step 312 be remote widget system 200 EXE is downloaded and installed at step 313. At step 314, the remote widget system 200 EXE is launched. The widget acquire agent 300 then exits at step 319.

FIG. 8A is a flow chart illustrating an example of the widget launch 180 on the server 11 that is utilized in the widget system 100 of the present invention, as shown in FIGS. 2A and 4A. When a widget is launched on remote device 15. The desktop widget will send it's version number to a widget provider. The widget provider compares the version number of the launched widget to the data in the database 12 for that widget and will return the URL of a new widget if the version numbers do not match. Otherwise, it will return an OK status indicating that the widget is the most current version. On the desktop of remote device 15, an OK status is ignored since no further action is needed. Otherwise the new widget will be popped from the URL sent from the server 11 and opened at the same position & size as the ‘old’ widget. The ‘old’ widget instance will be closed thus creating the illusion of a seamless update.

First at step 181, the widget launch 180 is initialized. This initialization includes the startup routines and processes embedded in the BIOS of the server 11. The initialization also includes the establishment of data values for particular data structures utilized in the widget launch 180.

At step 182, the server receives a request for a widget update. In the request is a version number of the widget being tested for newer version. At step 183, the widget launch 180 compares the version number received with the version number of the most current version of the widget in the database 12.

At step 184, it is determined if the widget version number received matches the version number of the vote most current version of the widget in the database 12. If it is determined that the widget version numbers match, then the widget launch 180 returns an OK message at step 185. However, if it is determined at step 184 that the version numbers of the widgets do not match, then the widget launch 180 returns the URL of the new widget, at step 186.

At step 189, the widget launch 180 then exits.

FIG. 8B is a flow chart illustrating an example of the operation of the widget launch agent 320 on the remote device 15 that is utilized in the widget system 200 of the present invention, as shown in FIGS. 2B and 4B. When a widget is launched from the launch pad, a desktop widget will send it's version number to a widget provider. The widget provider compares the version number of the launched widget to the data in the database for that widget and will return the URL of a new widget if the numbers do not match up, otherwise it will return an OK indicating that the widget is the most current version. On the desktop an OK is ignored since no further action is needed. Otherwise the new widget will be popped from the URL sent from the server and opened at the same position & size as the ‘old’ widget. The ‘old’ widget instance will be closed thus creating the illusion of a seamless update.

First at step 321, the widget launch agent 320 is initialized. This initialization includes the startup routines and processes embedded in the BIOS of the remote device 15. The initialization also includes the establishment of data values for particular data structures utilized in the new widget agent 340.

At step 322, a user launches a widget from the desktop of remote device 15. At step 323, the widget launch agent through 20 sends a request to the server 11 to determine if being desktop contains the most current version of the widget being launched.

At step 324, it is determined if the URL is returned from the server 11. It is determined at step 324 that an OK status was in return instead of a URL, then be widget launch agent 320 skips to step 329. However, it is determined to step 324 that the URL was returned, then the widget launch agent 320 acquires a new widget from the URL at step 325. The acquisition of the new widget is herein defined in further detail with regard to FIG. 8C.

At step 399, the widget launch agent 320 then exits.

FIG. 8C is a flow chart illustrating an example of the operation of the new widget agent 340 on the remote device 15 that is utilized in the widget system 200 of the present invention, as shown in FIGS. 2B and 4B. the new widget agent 340 transmits processes and updates, new widget data when it is determined that being newer version of the widget being launched is available.

First at step 341, the new widget agent 340 is initialized. This initialization includes the startup routines and processes embedded in the BIOS of the remote device 15. The initialization also includes the establishment of data values for particular data structures utilized in the new widget agent 340.

At step 342, the new widget agent 340 transmits data including the URL, X/Y position for the widget, the width and height, and user & system platform parameters to the widget system 100 on server 11. The user parameters include anything that applies to the widget configuration that the user can set or modify. System parameters include, but are not limited to, tracking, partner IDs, widget instance IDs, and the like.

At step 342, the new widget agent 340 waits to receive transmission data and processes that data once received at step 343. At step 344, the new widget agent 340 checks the domain of the new widget URL in the data received. If the domain of the new widget data received is not from an allowed domain, the process is aborted and proceeds to step 359. Allowed domains are preconfigured in the remote widget system 200 when loaded onto the remote device. Allow domains are updated any time a widget is downloaded from server 11 as a trusted widget.

In an alternative embodiment, allowed domains are updated any time widget data is downloaded from server 11. In another alternative embodiment, the allowed domains are updated by being downloaded from the widget system 100 on server 11 at each start of the remote widget system 200 on the remote device 15. In still another alternative embodiment, the allowed domains are updated any time the remote widget system 200 requests the latest allowed domain from the widget system 100 on server 11. In another alternative embodiment, the remote widget system 200 may send a request to widget system 100 to validate a specific domain.

At step 345, the new widget agent 340 then instantiates a generic component wrapper window with the X/Y position, height and width, and parameters as defined at step 342. A step 351, the user receives a message telling the user if the new widget is not enabled, or if it's a non-trusted widget. A non-trusted widget would be a widget that was supplied by a third party. If the widget is not enabled, or it the user decides not to download a non-trusted widget, then the new widget agent 340 proceeds to step 359.

A step 352, the new widget agent 340 then downloads the new widget component from the URL. At step 353, it is determined if there are more new widget components be downloaded from the URL. If it is determined at step 353 that there are more components to be downloaded, and the new widget agent 340 returns to repeat steps 344 and 345. However, it is determined in step 353 that there are no more new widget components to be downloaded, the new widget agent 340 then loads the downloaded new widget components into a widget wrapper with the defined parameters at step 354. Loading the components executes the new widget on the remote device 15. At 359, the new widget agent 340 then exits.

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. A system for automatically updating a widget, comprising:
means for receiving widget data from a desktop application;
means for determining if the widget being launched is the most current; and
means for downloading at least one component for the widget if a newer version is available.

2. The system of claim 1, further comprising means for activating the widget.

3. The system of claim 1, further comprising means for verifying that the widget is available for download.

4. The system of claim 1, further comprising means for verifying that the widget is on the server.

5. The system of claim 1, wherein the component downloading means further comprises means for downloading a URL to the remote device.

6. The system of claim 1, further comprises means for transmitting a listing of trusted domains to the desktop application when the desktop application requests the current listing of trusted domains.

7. A system for automatically updating a widget, comprising:
a receiving module that receives widget data from a desktop application;
a version determination module that determines if the widget being launched is the most current; and
a download module that downloads at least one component for the widget if a newer version is available.

8. The system of claim 7, further comprising activate module that activates the widget.

9. The system of claim 7, further comprising a verification module that verifies the widget is available for download.

10. The system of claim 7, further comprising a verification module that verifies that the widget is on the server.

11. The system of claim 7, wherein the downloading module further comprises means for downloading a URL to the remote device.

12. The system of claim 7, further comprising a transmission module that transmits a listing of trusted domains to the desktop application when the desktop application requests the current listing of trusted domains.

13. A computer program product, the computer program product comprising:
a tangible storage medium readable by a processing circuit and storing instructions for execution by the processing circuit for performing a method comprising:
receiving widget data from a desktop application;
determining if the widget being launched is the most current; and
downloading at least one component for the widget if a newer version is available.

14. The computer program product of claim 13, further comprising activating the widget.

15. The computer program product of claim 13, further comprising verifying that the widget is available for download.

16. The computer program product of claim 13, further comprising verifying that the widget is on the server.

17. The computer program product of claim 13, further comprising downloading a URL to the remote device.

18. The computer program product of claim 13, further comprising transmitting a listing of trusted domains when the desktop application requests the current listing of trusted domains.
